(19) United States
(12) Patent Application Publication
(10) Pub. No.: US 2021/0240459 A1
(43) Pub. Date: Aug. 5, 2021

(54) SELECTION OF DEPLOYMENT ENVIRONMENTS FOR APPLICATIONS

(71) Applicant: Hewlett Packard Enterprise Development LP, Houston, TX (US)

(72) Inventors: Jyoti Ranjan, Bangalore Karnataka (IN); Prabhu Murthy, Bangalore Karnataka (IN); Abhishek Kumar, Bangalore Karnataka (IN)

(21) Appl. No.: 17/073,323

(22) Filed: Oct. 17, 2020

(30) Foreign Application Priority Data
Jan. 31, 2020 (IN) 202041004459

(51) Int. Cl. G06F 8/60; G06F 9/50

(52) U.S. Cl. CPC G06F 8/60; G06F 9/5055

(57) ABSTRACT

Example techniques for selection of deployment environments for applications are described. The deployment environments may be container-based deployment environments. In an example, the selection may be performed based on a historical behavior of an application.

### BACKGROUND

An application may refer to a program or a group of programs designed to perform a function or a group of coordinated functions. An application may be hosted in a deployment environment for handling service requests, for example, from users.

### BRIEF DESCRIPTION OF DRAWINGS

The following detailed description references the figures, wherein:

FIG. 1 illustrates a system for facilitating selection of an application deployment environment for deployment of an application, according to an example implementation of the present subject matter.

FIG. 2 illustrates a block diagram of a system that is to recommend a deployment environment for deployment of an application, according to an example implementation of the present subject matter.

FIG. 3 illustrates deployment of applications in deployment environments, according to an example implementation of the present subject matter.

FIG. 4 illustrates a method for deploying an application in an application deployment environment, according to an example implementation of the present subject matter.

FIG. 5 illustrates a method for facilitating selection of an application deployment environment for deployment of an application, according to an example implementation of the present subject matter.

FIG. 6 illustrates a method for selecting a deployment environment based on consideration of costing models of the deployment environments, according to an example implementation of the present subject matter.

FIG. 7 illustrates a computing environment implementing a non-transitory computer-readable medium for selection of an application deployment environment for deployment of an application, according to an example implementation of the present subject matter.

### DETAILED DESCRIPTION

An application may be deployed in a container, which may be a computing instance that can host the application and can operate as a separate computing device from the point of view of the application. A deployment environment in which applications are deployed in containers may be referred to as a container-based deployment environment. Example container-based deployment environments are a container platform environment and a serverless computing environment.

A container platform environment includes a cluster of computing nodes, in which each computing node may run one or more containers. The computing nodes may continue to run a container even when the application is not servicing service requests from users. A serverless computing environment may receive an application code corresponding to an application and execute the application code upon invocation. The application code is executed in a container, which may be terminated upon execution of the application code. Accordingly, containers in the container platform environment are generally kept alive for a longer period of time as compared those in the serverless computing environment.

Generally, prior to deployment of an application, a suitable deployment environment for the application may not be selected from among the various deployment environments. For instance, the application may be deployed in the container platform environment without examining a suitability of the serverless computing environment to host the application. The deployment without examination of the suitability may lead to wastage of computational resources, reduced performance of the application, and increase in cost incurred for operating the application.

The present subject matter relates to selection of deployment environments for deployment of applications. With the implementations of the present subject matter, an application may be deployed in a suitable deployment environment.

In accordance with an example implementation, an application deployment environment is selected for an application based on a historical behavior of the application. The historical behavior may include, for example, frequency of operation of the application, runtime duration of the application for each initiation of the application, and workload pattern of the application. The workload pattern may refer to a manner in which the application receives service requests over a period of time.

The historical behavior of the application may be used to infer a suitability of an application deployment environment to host the application. For instance, the historical behavior of the application may include a frequency of operation of the application, which indicates how frequently the application is operated, for example, to handle service requests. If the application is operated at a relatively higher frequency, such as above a frequency threshold, it may be determined that the container platform environment is suitable for deployment of the application. This is because, as explained earlier, containers in the container platform are run continuously even if service requests are not received. Accordingly, as and when service requests are received, the application in the container platform may handle the service requests.

In an example, a cost for hosting an application may differ from one deployment environment to another. For instance, while the cost for hosting the application in the serverless computing environment may depend on number of invocations of the application, the cost for hosting the application in the container platform environment may be fixed, for example, for a day or a month, and may not depend on the number of invocations. Accordingly, in an example, the cost that is likely to be incurred for operating the application in each application deployment environment may be estimated. To estimate the cost, the historical behavior of the application and a costing model of each application deployment environment may be utilized. A deployment environment in which lesser cost is likely to be incurred may be selected for deployment of the application. Thus, the cost incurred in deploying applications to container-based application deployment environments may be reduced.

The present subject matter provides efficient and improved techniques for selecting application deployment environments for applications. The present subject matter can be utilized for determining deployment environments for deploying applications in container-based deployment environments. Using the present subject matter, the cost incurred in deploying applications and a suite of applications in container-based deployment environments can be significantly reduced. Further, the performance of the applications can be improved, as the applications are hosted in deployment environments based on the suitability of the deployment environment.

The following description refers to the accompanying drawings. Wherever possible, the same reference numbers are used in the drawings and the following description to refer to the same or similar parts. While several examples are described in the description, modifications, adaptations, and other implementations are possible and are intended to be covered herein.

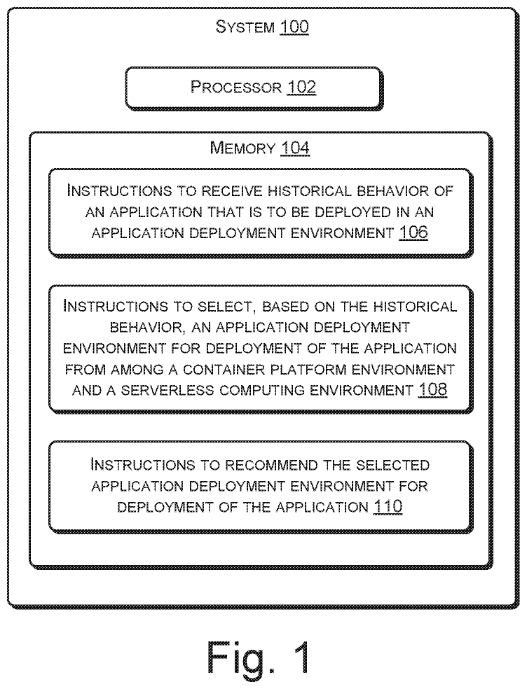

FIG. 1 illustrates a system 100 for facilitating selection of an application deployment environment for deployment of an application, according to an example implementation of the present subject matter. In an example, the system 100 may be implemented as a computing device, such as a desktop computer, a laptop computer, a server, or the like. In another example, the system 100 may be implemented as a plurality of computing devices. The system 100 includes a processor 102 and a memory 104 coupled to the processor 102.

The processor 102 may be implemented as microprocessors, microcomputers, microcontrollers, digital signal processors, central processing units, state machines, logic circuitries, and/or any devices that manipulate signals based on operational instructions. Among other capabilities, the processor 102 may fetch and execute computer-readable instructions included in the memory 104. The computer-readable instructions, hereinafter referred to as instructions, include instructions 106, instructions 108, and instructions 110. The functions of the processor 102 may be provided through the use of dedicated hardware as well as hardware capable of executing machine readable instructions.

The memory 104 may include any non-transitory computer-readable medium including volatile memory (e.g., RAM), and/or non-volatile memory (e.g., EPROM, flash memory, Memristor, etc.). The memory 104 may also be an external memory unit, such as a flash drive, a compact disk drive, an external hard disk drive, or the like.

In addition to the processor 102 and the memory 104, the system 100 may also include interface(s) and system data (not shown in FIG. 1). The interface(s) may include a variety of machine-readable instructions-based interfaces and hardware interfaces that allow interaction with a user and with other communication and computing devices, such as network entities, web servers, and external repositories, and peripheral devices. The system data may serve as a repository for storing data that may be fetched, processed, received, or created by the instructions.

In operation, the system 100 may facilitate selection of an application deployment environment for deployment of an application by executing the instructions 106-110. An application deployment environment may be interchangeably referred to as a deployment environment and may refer to a computing environment in which an application can be deployed. The deployment environment may be implemented in a computing device or in a network of computing devices. In an example, the deployment environment may be a container-based deployment environment, i.e., a deployment environment in which applications are deployed in containers. Examples of the deployment environment are a container platform environment and a serverless computing environment.

The processor 102 may execute the instructions 106 to receive historical behavior of an application that is to be deployed in a deployment environment. The historical behavior of the application may be used to infer a suitability of an application deployment environment to host the application. For instance, the historical behavior of the application may include a frequency of operation of the application, which indicates how frequently the application is operated. If the application is operated at a relatively higher frequency, such as above an operation threshold, it may be determined that the container platform environment is suitable for deployment of the application. This is because containers in the container platform are run continuously even if service requests are not received. Contrarily, if the application is run in a serverless computing environment, a container running the application may be instantiated and terminated frequently.

Accordingly, based on the historical behavior, the processor 102 may execute the instructions 108 to select a deployment environment for deployment of the application from among the container platform environment and the serverless computing environment. The processor 102 may then recommend the selected application deployment environment for deployment of the application by executing the instructions 110. The historical behavior and the selection of the deployment environment based on the historical behavior is explained in greater detail below.

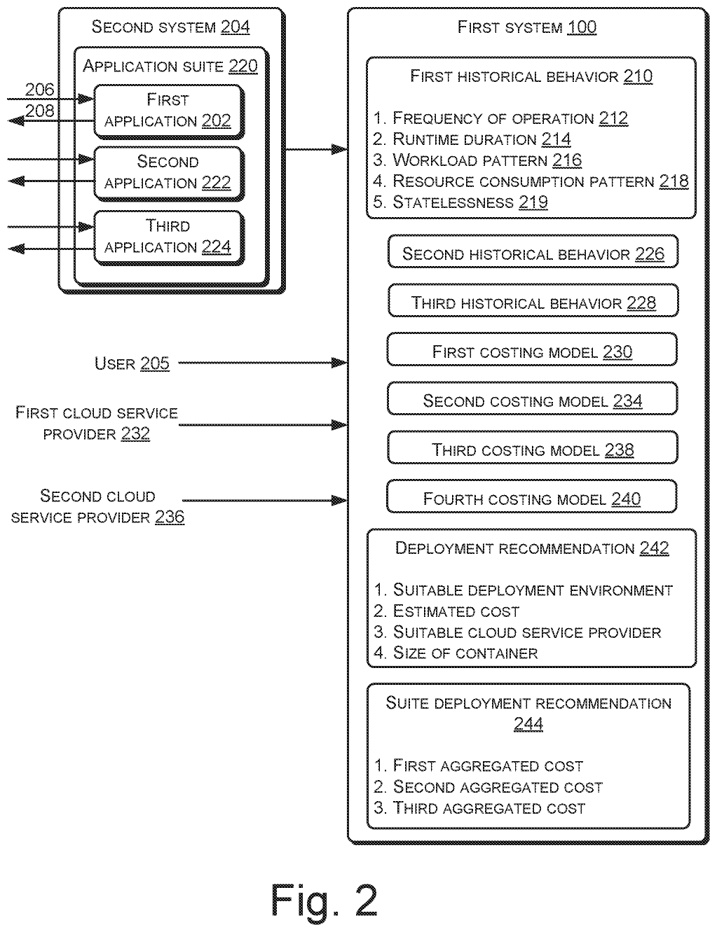

FIG. 2 illustrates a block diagram of the system 100 that is to recommend a deployment environment for deployment of an application, according to an example implementation of the present subject matter. Applications may be deployed in a cloud computing environment, which may have a plurality of networked computing devices. In an example, the cloud computing environment may be a private cloud, which may be utilized by users belonging to an organization that owns and manages the private cloud, and may not be utilized by others. Examples of a private cloud may include an on-premises cloud, which may include a data center or computing devices deployed on the premises of a particular organization. In another example, the cloud computing environment may be a public cloud, which can be utilized by users outside of the organization that owns and manages, typically on payment of an agreed-upon cost. In a further example, the cloud computing environment may be a hybrid cloud, in which a mix of private cloud and public cloud is used for deploying applications with an orchestration between the private cloud and the public cloud.

In the cloud computing environment, an application may be deployed in a deployment environment, which facilitates running of the application and handling of service requests by the application. Some deployment environments deploy the applications in containers, which are environments that can isolate applications from computing devices they are hosted in and from other processes running on the computing devices. The containers may provide, among other things, code, runtime, system tools, system libraries, and settings to the applications. Further, the containers can provide a consistent runtime environment to the applications regardless of the computing devices they are hosted in. Such deployment environments, which deploy applications in containers, may be referred to as container-based deployment environments. Further, the applications that are deployed in the containers are referred to as containerized applications.

Some example container-based deployment environments are a serverless computing environment and a container platform environment. A serverless computing environment may receive an application code corresponding to an application and execute the application code upon invocation. The application code is executed in an ephemeral container, which may be terminated upon execution of the application code. Examples of serverless computing environment are Google Run™ and AWS (Amazon Web Services) Lambda™. Contrary to the serverless computing environment, the containers in a container platform environment are typically long-lived. For instance, a container in the container platform environment may be functional even if the application deployed in the container is not invoked and may not terminated without an explicit command to that effect. Examples of container platform environment are Amazon EKS™ (Elastic Kubernetes Service) and Google Kubernetes Engine (GKE™).

An application to be containerized may be deployed in any container-based deployment environment. Generally, a suitability of a container-based deployment environments is not determined before deploying the application. For instance, an application may be deployed in a container platform environment without examining its suitability with the serverless computing environment. The present subject matter facilitates determination of a suitable container-based deployment environment for deployment of the application, as will be described below. In the below description, the terms “container-based deployment environment” and “deployment environment” are used interchangeably.

In accordance with the present subject matter, the system 100 determines a suitable deployment environment for an application. To determine the suitable deployment environment, the system 100 may consider historical behavior of the application. The historical behavior of the application may include various parameters describing the operation of the application in the past. For instance, the historical behavior may include a frequency of operation of the application, a runtime duration of the application, a workload pattern of the application, a resource consumption pattern of the application, or statelessness of the application, or any combination thereof. The parameters will be described below:

As mentioned above, the frequency of operation of the application may indicate a number of times the application operates per unit time. The application may be invoked for operation, for example, in response to a service request corresponding to the application. For instance, an application to process orders of a customer may operate on receiving an order from the customer. Some applications may receive service requests continually, and may have a high frequency of operation. Examples of such applications are database applications, banking applications, and storage applications. In an example, an application may be invoked periodically. For instance, an application initiating a backup operation may be invoked once in an hour.

The runtime duration of the application may refer to a duration for which the application runs for each initiation of the application. The runtime duration of the application may depend upon the complexity of the function that the application is to perform. For instance, an application that is to collect operating metrics of a device, a component, and the like may have a smaller runtime duration as compared to another application that is to detect vulnerability issues of a computing device. It may be noted that the frequency of operation and the runtime duration of an application may collectively indicate how active the application is, i.e., the total time period for which the application operates in a given period of time. For instance, an application that receives 5 service requests per hour and has a runtime duration of 3 minutes may be expected to be active for 15 minutes in one hour.

A workload pattern of the application may refer to a temporal pattern in which the application operates. The workload pattern may indicate a frequency at which the application operates at various points of time. For instance, the workload pattern may indicate that a frequency of operation of the application is higher between 10 AM-11 AM as compared to the remainder of the day or that the application operates for the first 5 minutes of each hour.

A resource consumption pattern of the application may indicate the amount of resources, such as memory, processor, and storage, consumed by the application.

Statelessness of an application denotes whether an application is a stateless application or a stateful application. A stateless application is an application that does not save data of a client generated in one session for use in a subsequent session with the client. Example of a stateless application is a load-balancer application. A stateful application saves data of the client from each session and uses the data during the subsequent session with the client. Example of a stateful application is an application utilizing a database.

The parameters described above may be utilized to determine a suitable deployment environment for an application, as will be described below with the help of a few examples.

A high frequency of operation of the application may indicate that the container platform environment is more suitable for the application than the serverless computing environment. This is because, in case of the serverless computing environment, a container hosting the application may be terminated upon the application completing its operation and re-instantiated upon invocation. Accordingly, a high frequency of operation may result in several instantiations and terminations of the container hosting the application. Contrarily, in the container platform environment, since the containers remain active even after the application completes one operation, the application may be run in the same container for the next service request, thereby working more efficiently. In an example, the container platform environment may be selected as the suitable deployment environment if the frequency of operation is higher than an operation threshold.

A low frequency of operation may indicate that the serverless computing environment is a suitable deployment environment. This may be because, if a low frequency application is deployed in the container platform environment, the application may remain idle for prolonged periods of time, which may cause wastage of resources to keep the container alive.

A high frequency of operation coupled with a large runtime duration may indicate that the application is highly active, as explained earlier. Accordingly, the container platform environment may be the suitable deployment environment. Contrarily, for a low frequency of operation coupled with a small runtime duration, the serverless computing environment may be the suitable deployment environment.

A workload pattern indicating that the application operates at a high frequency for a small time window, while being fairly idle at other time windows may indicate that the serverless computing environment is the suitable deployment environment for the application. On the other hand, a stable workload pattern, which indicates that the application operates at a relatively uniform frequency regardless of the time window may indicate that the container platform environment is the suitable deployment environment. In an example, if the workload pattern is stable, the container platform environment may be selected as the suitable deployment environment.

The resource consumption pattern may indicate a cost that is likely to be incurred to provide the resources for operation of the application. The cost may be used to determine cost for deployment of the application in a deployment environment. The cost may be used to select the suitable deployment environment, as would be explained later.

For a stateful application, the container platform environment may be the suitable deployment environment, as the container hosting the application may be kept alive after one session with the client. Hence, data persisted by the application during one session with the client may be utilized by the application during the subsequent session.

Accordingly, based on the historical behavior, the system 100 may determine the suitable deployment environment for applications. An example application for which the suitable deployment environment is to be determined is a first application 202. The suitable deployment environment may have to be determined for various reasons. For example, the first application 202 may be a newly-developed application that is yet to be deployed. In another example, the first application 202 may be already deployed in a private cloud and may have to be migrated to a public cloud.

To obtain the historical behavior, the system 100 may monitor operation of the first application 202. In an example, if the first application 202 is yet to be deployed, the first application 202 may deployed temporarily in any deployment environment for obtaining the historical behavior. The first application 202 may be hosted in a second system 204. The second system 204 may be implemented as a computing device or as a plurality of computing devices. For ease of discussion, the system 100 may be referred to as the first system 100.

In an example, the first system 100 may initiate the monitoring upon receiving an instruction to select a deployment environment for the first application 202, for example, from a user 205. The user 205 may be, for example, a developer or an administrator of the first application 202. The instruction may include details of the first application 202, such as an identifier of the first application 202, which can be used to monitor the operation.

To monitor the operation, in an example, the first system 100 may interact with the first application 202. For the interaction, the first system 100 may utilize an application programming interface (API), such as a Representational State Transfer (REST) API. While being hosted in the second system 204, the first application 202 may receive service requests and provide responses to the service requests, as illustrated by arrows 206 and 208 respectively. The monitoring of the operation may be performed for a predetermined time period. The predetermined time period may be selected such that the various trends and seasonality in the operation of the first application 202 can be captured. In an example, the predetermined time period may be 30 days. The operation of the first application 202 over the predetermined period of time may be utilized to obtain the historical behavior 210 of the first application 202, also referred to as the first historical behavior 210. To obtain the historical behavior 210, in an example, the first system 100 may apply deep learning on the information received from the first application 202. As explained earlier, the first historical behavior 210 may include a frequency of operation 212, a runtime duration 214, a workload pattern 216, a resource consumption pattern 218, and statelessness 219.

In an example, based on the first historical behavior 210, the first system 100 may determine whether the first application 202 can be decomposed into a plurality of applications. Such a determination may be performed, for example, by monitoring interaction of the first application 202 with other applications. If it is determined that the first application can be broken into a plurality of applications, the user 205 may be notified. If the application cannot be broken or if the user 205 provides an input that no breaking down is to be performed, the first system 100 may proceed to determine a suitable deployment environment for the first application 202. If the first application 202 is broken down, the first system 100 may proceed to determine a suitable deployment environment for each newly-formed application. In the below description, the determination of suitable deployment environment for the first application 202 is described.

In an example, the first application 202 may be part of a suite of applications 220, which refers to a collection of applications that are related to each other in terms of functions or another criterion. The suite of applications 220 may also be referred to as the application suite 220 and may include a second application 222 and a third application 224, in addition to the first application 202. In an example, the application suite 220 may include several applications, such as hundreds of applications. Each application of application suite 220 may have to be deployed in a deployment environment. Accordingly, the first system 100 may monitor operation of each application of the application suite 220 to obtain historical behavior of the applications. The first system 100 may determine the suitable deployment environment for each application of the application suite 220 based on its respective historical behavior. For instance, based on a second historical behavior 226 of the second application 222 and a third historical behavior 228 of the third application 224, the first system 100 may select the suitable deployment environment for the second application 222 and the third application 224 respectively.

Although the second system 204 is shown as being different than the first system 100, in an example, the second system 204 may be part of the first system 100. Further, in an example, the monitoring of the operation may not be performed by the first system 100. Instead, the historical behavior may be received by the first system 100 as an input, for example, from the user 205. In a further example, the historical behavior may be monitored by the first system 100 and also received from a user. Further, in case of a conflict between the monitored behavior and the received behavior, in an example, the received behavior may override the monitored behavior or vice-versa. The overriding may be based on, for example, an input from the user 205.

In an example, in addition to the historical behavior, other criteria may be utilized to determine the suitable deployment environment for the first application 202. The other criteria may include a cost to be incurred for deploying the first application 202 in a deployment environment. To assess the cost, a costing model of a deployment environment may be utilized. The costing model of a deployment environment may indicate the dependence of the cost to be incurred for deploying the first application in the deployment environment on an expected behavior of the first application 202. The expected behavior can be determined from the first historical behavior 210. For instance, the expected behavior may include an expected frequency of operation, an expected runtime duration, an expected workload pattern, an expected resource consumption pattern, and an expected statelessness of the first application 202, which can be determined from the frequency of operation 212, the runtime duration 214, the workload pattern 216, the resource consumption pattern 218, and the statelessness 219 respectively. The assessment of the cost based on the costing model is explained below with the help of a few examples.

A first costing model 230 of the container platform environment may indicate the cost that would be incurred for hosting a container for a particular period of time as a function of resources consumed by the container and the application hosted by the container. As will be understood, the resources consumed by the container that is to host the first application 202 may be determined based on various parameters of the first historical behavior 210. The first costing model 230 may be provided by a cloud service provider that provides the container platform environment, such as a first cloud service provider 232. Example cloud service providers are AWS™ and GCP™ (Google Cloud Platform).

A second costing model 234 of the serverless computing environment may indicate the cost that would be incurred for hosting a container as a function of the time for which the container is alive, and the resources consumed by the container and the application hosted by the container. As will be understood, the time for which the container hosting the first application 202 would be kept alive and the resources that would be consumed by such a container may be determined based on various parameters of the first historical behavior 210. The second costing model 234 may be provided by a cloud service provider that provides the serverless computing environment, which may be the first cloud service provider 232.

Based on the first costing model 230, the second costing model 234, and the first historical behavior 210, the first system 100 may assess the cost that is likely to be incurred for hosting the first application 202 in the container platform environment and in the serverless computing environment. The cost likely to be incurred for hosting the first application 202 in the container platform environment and in the serverless computing environment may be referred to as a first cost and a second cost respectively. Based on the first cost and the second cost, the suitable deployment environment may be selected. For instance, the deployment environment in which lesser cost is likely to be incurred may be selected as the suitable deployment environment for the first application 202.

The first system 100 may also select the suitable deployment environment for other applications of the application suite 220. Thus, the present subject matter also facilitates reducing the cost that would be incurred for deploying and operating a suite of applications in deployment environments.

In some cases, deployment environments may be provided by more than one cloud service provider. Accordingly, the first system 100 may also select a suitable cloud service provider, in addition to selecting the suitable deployment environment for the first application 202. Subsequently, the first application 202 may be deployed in the suitable deployment environment provided by the suitable cloud service provider.

To determine the suitable cloud service provider, in an example, the first system 100 may receive costing models of several cloud service providers, such as the first cloud service provider 232 and a second cloud service provider 236. The costing models may be received from the cloud service providers or the user 205. The costing model corresponding to the serverless computing environment provided by the second cloud service provider 236 may be referred to as a third costing model 238 and the costing model corresponding to the container platform environment provided by the second cloud service provider 236 may be referred to as a fourth costing model 240. Based on the third costing model 238 and the first historical behavior 210, the first system 100 may assess a third cost of operating the first application 202 in the serverless computing environment provided by the second cloud service provider 236. Similarly, based on the fourth costing model 240 and the first historical behavior 210, the first system 100 may assess a fourth cost of operating the first application 202 in the container platform environment provided by the second cloud service provider 236. Thereafter, based on a comparison of the first cost, the second cost, the third cost, and the fourth cost, the first system 100 may select the suitable deployment environment and the suitable cloud service provider. For instance, if the third cost is determined as being the least among the four costs, the first system 100 may select the second cloud service provider 236 as the suitable cloud service provider and the serverless computing environment as the suitable deployment environment for the first application 202.

In another example, the suitable cloud service provider may be determined based on a cloud service provider input provided by the user, which may specify the cloud service provider whose deployment environment is to be used for deploying an application.

Upon determining the suitable deployment environment, the first system 100 may provide a recommendation to deploy the first application 202. The recommendation may be referred to as a deployment recommendation 242 or deployment attributes for the first application 202. The deployment recommendation 242 may include, for example, the suitable deployment environment and an estimated cost that is likely to be incurred for hosting the first application 202 in the suitable deployment environment. In an example, the deployment recommendation 242 may also include the estimated cost likely to be incurred for deploying the first application 202 in deployment environments other than the suitable deployment environment. For instance, if the suitable deployment environment is the serverless computing environment, the deployment recommendation 242 may also indicate the estimated cost likely to be incurred for deploying the first application 202 in the container platform environment. The provision of estimated costs for both the suitable deployment environment and the other deployment environments (e.g., the first cost and the second cost) allows a comparison of the costs and understanding the cost savings likely to be achieved.

The deployment recommendation 242 may also include a recommendation as to the suitable cloud service provider. Further, the deployment recommendation 242 may include a recommended size of the container. The recommended size may be determined by the first system 100 based on the resource consumption pattern 218.

The deployment recommendation 242 may be provided, for example, to the user 205. The deployment recommendation 242 may be provided as a visual output, for example, on a display of the first system 100 or a display of a computing device used by the administrator. Similar recommendations may also be provided for other applications of the application suite 220.

In an example, instead of providing deployment recommendation for each application separately, the system 100 may provide a deployment recommendation for the entire application suite 220. Such a deployment recommendation may be referred to as a suite deployment recommendation 244. The suite deployment recommendation 244 may indicate suitable deployment environments of each application of the application suite 220. The suite deployment recommendation 244 may also indicate suitable cloud service providers for each application and recommended container size for each application. In addition, the suite deployment recommendation may include a first aggregated cost, a second aggregated cost, and a third aggregated cost. The first aggregated cost may be the cost likely to be incurred for deploying each application of the application suite 220 in the container platform environment. The second aggregated cost may be the cost likely to be incurred for deploying each application of the application suite 220 in the serverless computing environment. The third aggregated cost may refer to the cost likely to be incurred for deploying each application of the suite in its respective suitable deployment environment. Such a cost estimate may be obtained by summing estimated costs for each application of the application suite 220. The various aggregated costs may provide an idea of the cost savings likely to be achieved by deploying the applications in their respective suitable deployment environments. Thus, an administrator of the application suite 220 may make an informed decision regarding deployment of applications of the application suite 220. Therefore, the present subject matter may improve and simplify the process of deployment of applications in deployment environments. Upon providing the recommendations, the applications may be deployed in their respective suitable deployment environments, as will be explained below.

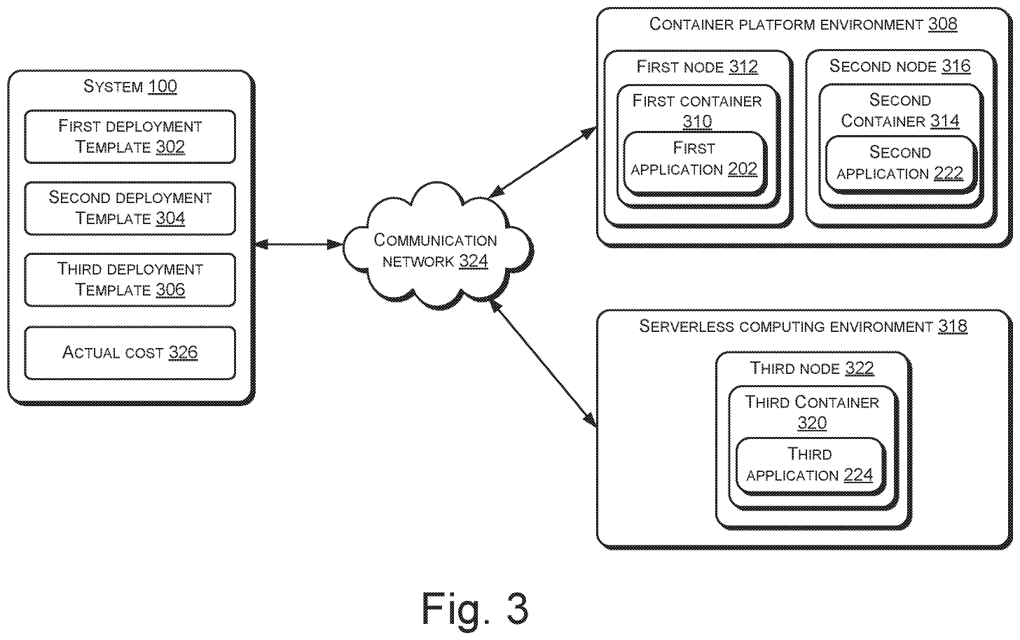

FIG. 3 illustrates deployment of applications in deployment environments, according to an example implementation of the present subject matter. Upon receipt of the deployment recommendation of an application, such as the deployment recommendation 242, or the suite deployment recommendation 244, a user, such as an administrator, may provide a response to utilize the selected deployment environment for deploying the application.

Upon receiving the response, to deploy an application in its suitable deployment environment, the system 100 may generate a deployment template for the application, which facilitates deployment of the application in its suitable deployment environment. For instance, a first deployment template 302 may be generated corresponding to the first application 202, a second deployment template 304 may be generated corresponding to the second application 222, and a third deployment template 306 may be generated corresponding to the third application 224. The deployment template may include various details that facilitate in deployment of the application and the container that is to host the application. For instance, the deployment template may include configuration attributes for the application and resources to be provisioned for the application. The deployment template may be in a standard format, such as a JavaScript Object Notation (JSON) or YAML Ain't Markup Language (YAML) standard. The deployment template may be, for example, a CFN template in case of AWS™ and ARM (Azure Resource Manager) template in case of Microsoft™ Azure™.

The deployment templates may then be used to deploy the applications in their respective suitable deployment environments. For instance, if the suitable deployment environments for the first application 202 and the second application 222 are determined as the container platform environment 308, the first deployment template 302 and the second deployment template 304 may facilitate deployment in the container platform environment 308. Accordingly, using the first deployment template 302 and the second deployment template 304, the first application 202 and the second application 222 may be deployed in the container platform environment 308. In the container platform environment 308, in an example, the first application 202 may be deployed in a first container 310 in a first node 312 and the second application 222 may be deployed in a second container 314 in a second node 316. Similarly, if the suitable deployment environment for the third application 224 is the serverless computing environment 318, the system 100 may utilize the third deployment template 306 to deploy the third application 224 in the serverless computing environment 318. The third application 224 may be deployed in, for example, a third container 320 in a third node 322 of the serverless computing environment 318. As will be understood, the third container 320 may be terminated and re-instantiated for various operations of the third application 224.

To facilitate communication of the system 100 with the container platform environment 308 and the serverless computing environment 318, the system 100 may be connected to a communication network 324. The communication network 324 may be a wireless or a wired network, or a combination thereof. The communication network 324 may be a collection of individual networks, interconnected with each other and functioning as a single large network (e.g., the internet or an intranet). Examples of such individual networks include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 324 may include various network entities, such as transceivers, gateways, and routers.

Upon deployment, the system 100 may configure the attributes of the deployed application. In an example, a deployment template for an application may correspond to a suitable cloud service provider for the application. Accordingly, the deployment template may be utilized to deploy the application in the suitable deployment environment of the suitable cloud service provider. The deployment template may also specify a data center in which the application is to be deployed. Accordingly, using the deployment template, the application may be deployed in a specified data center. The data center to be specified may be determined based on a data center input provided, for example, by the user 205. The data center input may be provided by the user 205 when instructing for selecting a suitable deployment environment for the application.

In an example, the user 205 may make some modifications to the deployment recommendation. For instance, the user 205 may reject usage of the suitable deployment environment or the suitable cloud service provider for an application. The user 205 may also provide the data center input in response to the deployment recommendation. Based on the inputs provided by the user 205, the deployment template for the application may be generated and the application may be deployed accordingly. Thus, the present subject matter allows the user 205 to override the recommendations provided for the deployment.

Also, the user 205 may specify the data center based on the geographical locations of users of the application. For instance, the data center specified may be the data center that is in proximity to the users of the application. Therefore, by deploying the applications based on the data center input, it is ensured that applications are deployed proximal to its users, thereby reducing latency in communication between the applications and its users.

Upon deployment of the applications in the deployment environments, in an example, the system 100 may track the actual cost 326 incurred due to the deployment. The actual cost 326 may be obtained from the deployment environments or the cloud service providers. The actual cost 326 may also be published, for example, for viewing by the user 205. In an example, the actual cost 326 may be computed periodically, such as once a day or 30 days.

The actual cost 326 may then be compared with the third aggregated cost. If the actual cost 326 is higher than the third aggregated cost, the system 100 may identify the cause for the difference. The cause may be, for example, the difference in the behavior of an application as compared to its historical behavior, such as an increase in frequency of operation. To facilitate the comparison of costs and identification of the cause for the difference, the system 100 may store the third aggregated cost upon its estimation and the historical behavior. Based on the identified cause, the system 100 may determine whether the deployment environment for an application is to be changed and may change the deployment environment. Thus, the present subject matter allows dynamically updating deployment environments of applications and reduces cost involved in the deployment of the applications.

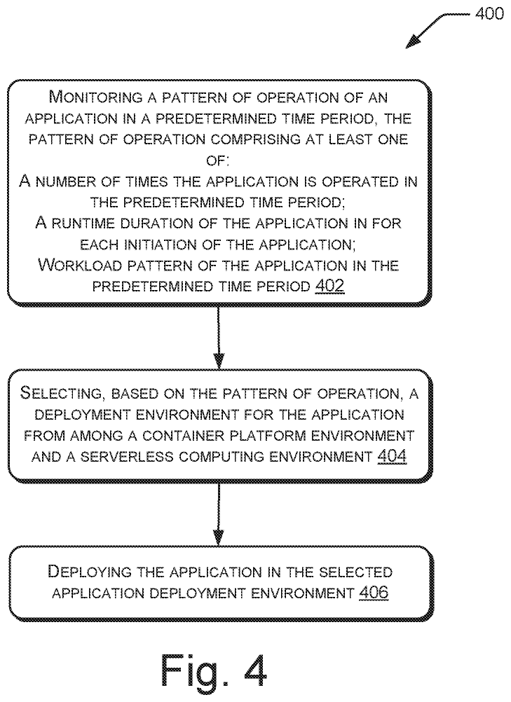

FIGS. 4, 5, and 6 illustrate methods 400, 500, 600 respectively for deploying an application in an application deployment environment, according to example implementations of the present subject matter.

The order in which the methods 400-600 is described is not intended to be construed as a limitation, and any number of the described method blocks may be combined in any order to implement the methods 400-600, or alternative methods. Furthermore, the methods 400-600 may be implemented by processing resource(s) or computing device(s) through any suitable hardware, non-transitory machine-readable instructions, or a combination thereof.

It may be understood that steps of the methods 400-600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. Further, although the methods 400-600 may be implemented in a variety of systems, the methods 400-600 are described in relation to the system 100, for ease of explanation. In an example, the steps of the methods 400-600 may be performed by a processing resource, such as the processor 102.

Referring to method 400, at block 402, a pattern of operation of an application in a predetermined period of time is monitored. The pattern of operation may include a number of times the application is operated in the predetermined time period, runtime duration of the application for each initiation of the application, or workload pattern of the application in the predetermined time period, or any combinations thereof. The application may be, for example, the first application 202. The monitoring of the pattern of operation may be performed by interacting with the application, for example, using APIs, as explained with reference to FIG. 2.

At block 404, based on the pattern of operation, a deployment environment may be selected for the application from among a container platform environment and a serverless computing environment. The container platform environment may be, for example, the container platform environment 308 and the serverless computing environment may be, for example, the serverless computing environment 318.

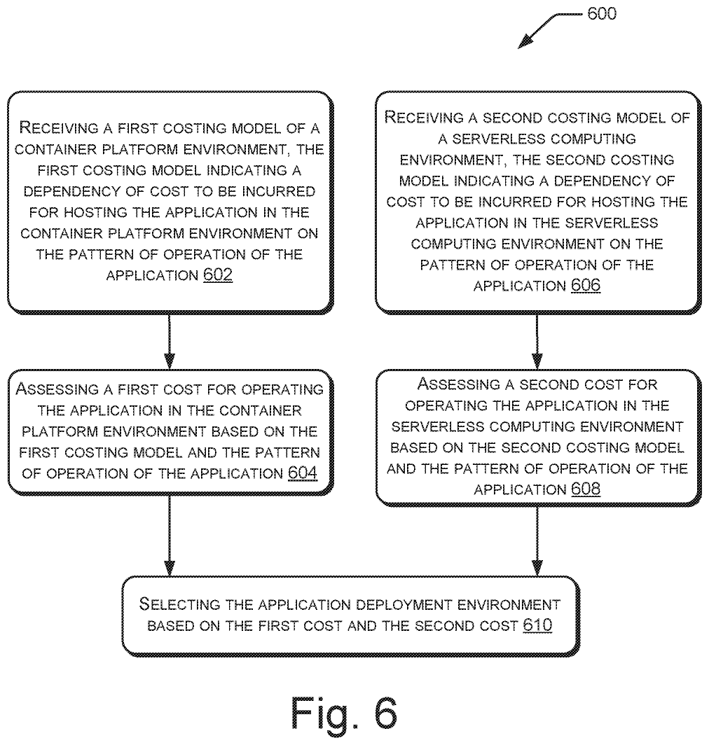

In an example, the container platform environment is selected as the deployment environment if the number of times the application is operated in the predetermined time period is greater than an operation threshold. The container platform environment may be selected if the runtime duration is greater than a runtime threshold. The threshold values may be provided, for example, by a user or may be determined using a machine learning technique. The threshold values may be selected based on, for example, a determination of a runtime duration and a number of times of operation, beyond which the container platform environment may be a suitable deployment environment. In a further example, container platform environment may be selected if the workload pattern of the application is stable. In an example, the selection of deployment environment may involve consideration of costing models of the deployment environments, as will be explained with reference to FIG. 6.

At block 406, the application may be deployed in the selected application deployment environment. In an example, the deployment may be performed upon obtaining approval for the selected deployment environment from a user, such as the user 205, as explained above. In an example, a data center input may be received, which may indicate a data center in which the application is to be deployed. The data center input may be received, for example, from the user. Subsequently, the application may be deployed in the selected deployment environment in the data center indicated.

In an example, the pattern of operation may include resource consumption pattern of the application, such as the resource consumption pattern 218. Based on the resource consumption pattern, a size of the container to be instantiated for deploying the application may be determined. Accordingly, the application may be deployed in a container having the determined size.

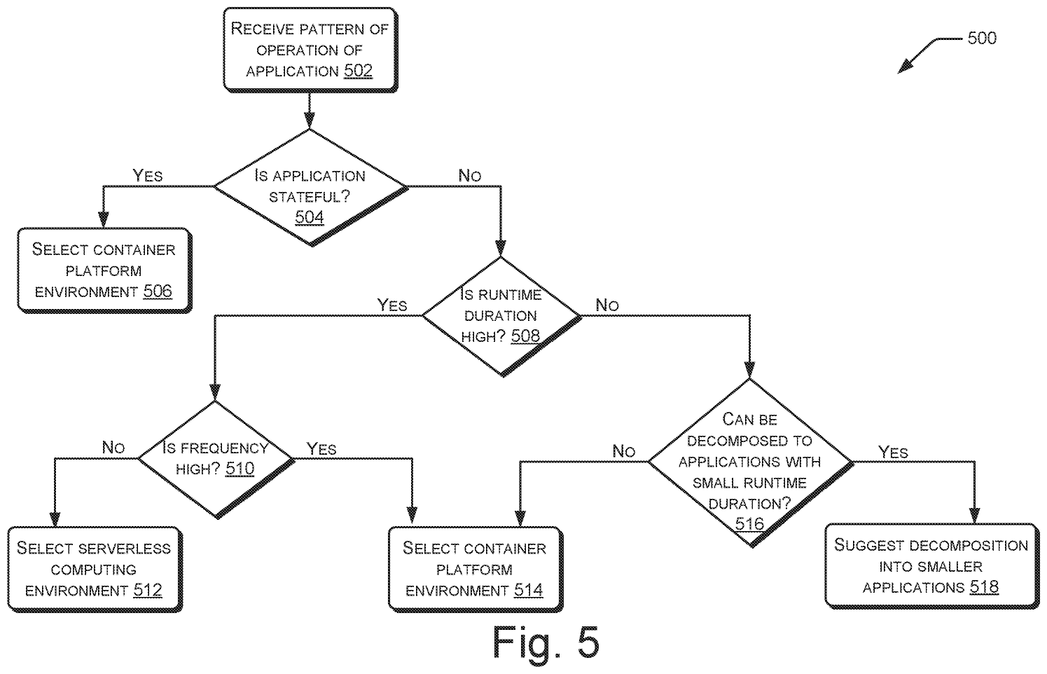

FIG. 5 illustrates a method 500 for facilitating selection of an application deployment environment for deployment of an application, according to an example implementation of the present subject matter.

At block 502, the pattern of operation of the application may be received. In an example, the pattern of operation may be received from a user. In another example, the pattern of operation may be obtained by a system that performs the methods 400 and 500 by interacting with the application.

At block 504, it is determined if the application is a stateful application. If the application is determined to be stateful, at block 506, the container platform environment may be selected as the deployment environment. If the application is determined to be stateless, at block 508, it is determined if the runtime duration of the application is high, such as greater than the runtime threshold. If the runtime duration is high, at block 510, it is checked if the frequency of operation of the application is high, such as greater than the operation threshold. If the frequency is not high, at block 512, the serverless computing environment is selected as the deployment environment. If the frequency is high, at block 514, the container environment is selected as the deployment environment.

If, at block 508, it is determined that the runtime duration of the application is not high, at block 516, it is determined if the application can be decomposed into smaller applications having smaller runtime durations. Such a determination may be performed, for example, based on interaction of the application with other applications. If yes, at block 518, a suggestion to perform the decomposition may be provided to the user. If no, at block 514, the container environment is selected as the deployment environment.

FIG. 6 illustrates a method 600 for selecting a deployment environment based on consideration of costing models of the deployment environments, according to an example implementation of the present subject matter. At block 602, a first costing model of the container platform environment, such as the first costing model 230, may be received. The first costing model may indicate a dependency of cost to be incurred for hosting the application in the container platform environment on the pattern of operation of the application. Based on the first costing model and the pattern of operation of the application, a first cost for deploying the application in the container platform environment may be assessed at block 604.

Similarly, at block 606, a second costing model of the serverless computing environment, such as the second costing model 234, is received. The second costing model may indicate a dependency of the cost to be incurred for hosting the application in the serverless computing environment on the pattern of operation of the application. The costing models may be received, for example, from the cloud service providers providing the deployment environments. Based on the second costing model, a second cost for deploying the application in the serverless computing environment may be assessed at block 608.

At block 610, a deployment environment may be selected based on the first cost and the second cost. For instance, a deployment environment in which lesser cost is likely to be incurred may then be selected as the deployment environment.

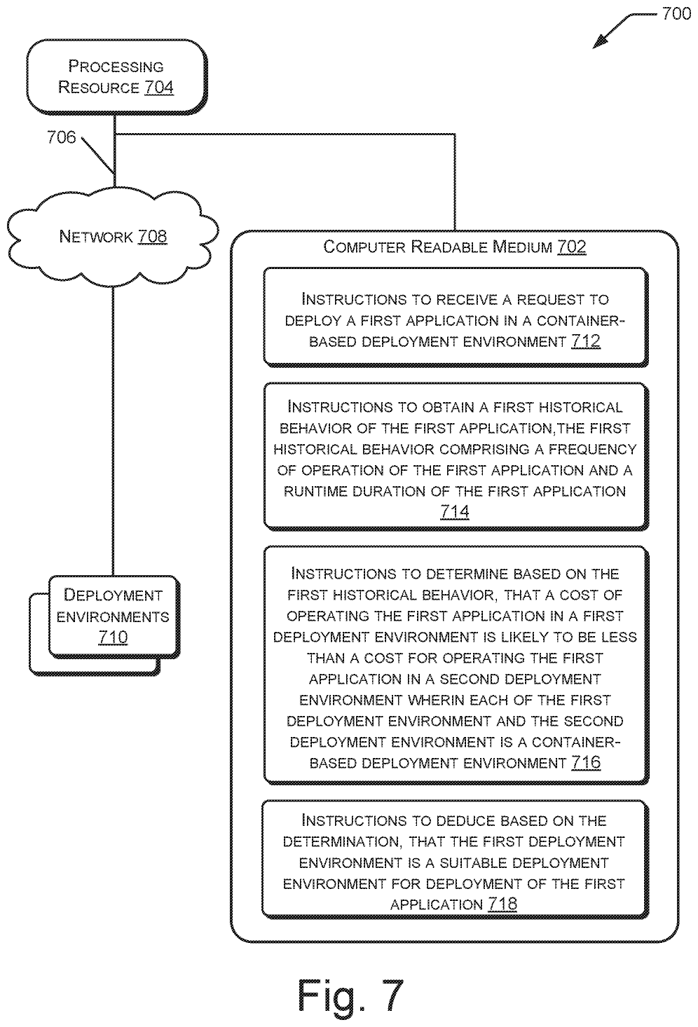

FIG. 7 illustrates a computing environment 700 implementing a non-transitory computer-readable medium 702 for selection of an application deployment environment for deployment of an application, according to an example implementation of the present subject matter.

In an example, the non-transitory computer-readable medium 702 may be utilized by a system, such as the system 100. In an example, the computing environment 700 may include a processing resource 704 communicatively coupled to the non-transitory computer-readable medium 702 through a communication link 706. The processing resource 704 may be, for example, the processor 102.

The non-transitory computer-readable medium 702 may be, for example, an internal memory device or an external memory device. In an example, the communication link 706 may be a direct communication link, such as any memory read/write interface. In another example, the communication link 706 may be an indirect communication link, such as a network interface. In such a case, the processing resource 704 may access the non-transitory computer-readable medium 702 through a network 708. The network 708 may be a single network or a combination of multiple networks and may use a variety of different communication protocols.

The processing resource 704 and the non-transitory computer-readable medium 702 may also be communicatively coupled to deployment environments 710 over the network 708.

In an example implementation, the non-transitory computer-readable medium 702 includes a set of computer-readable instructions to facilitate selection of an application deployment environment for deployment of an application. The set of computer-readable instructions can be accessed by the processing resource 704 through the communication link 706 and subsequently executed.

Referring to FIG. 7, in an example, the non-transitory computer-readable medium 702 includes instructions 712 that cause the processing resource 704 to receive a request to deploy a first application in a container-based deployment environment, also referred to as deployment environment. The first application may be, for example, the first application 202. The request may be received, for example, from a user, such as an administrator of the first application.

The non-transitory computer-readable medium 702 includes instructions 714 that cause the processing resource 704 to obtain a first historical behavior of the first application. The first historical behavior includes a frequency of operation of the first application and a runtime duration of the first application. The first historical behavior may be the first historical behavior 210.

The non-transitory computer-readable medium 702 includes instructions 716 that cause the processing resource 704 to determine that a cost for operating the first application in the first deployment environment is likely to be less than a cost for operating the first application in the second deployment environment. Such a determination may be performed based on the first historical behavior. The first deployment environment and the second deployment environment may be container-based deployment environment. The first deployment environment may be a container platform environment and the second deployment environment may be a serverless platform environment or vice-versa.

In an example, to determine that the cost for operating the first application in the first deployment environment is likely to be less than the cost for operating the first application in the second deployment environment, a first costing model of the first deployment environment and a second costing model of the second deployment environment may be utilized. The first costing model indicates a dependency of cost to be incurred for hosting the first application in the first deployment environment on the first historical behavior. Similarly, the second costing model indicates a dependency of cost to be incurred for hosting the first application in the second deployment environment on the first historical behavior. The first costing model may be the first costing model 230 and the second costing model may be the second costing model 234 or vice-versa.

The non-transitory computer-readable medium 702 includes instructions 718 that cause the processing resource 704 to deduce, based on the determination, that the first deployment environment is a suitable deployment environment for deployment of the first application.

In an example, the first application is part of a suite of applications, such as the application suite 220. Further, the instructions are executable to determine, from among the first deployment environment and the second deployment environment, a suitable deployment environment for each application of the suite based on a historical behavior of the application. For instance, a suitable deployment environment is determined for a second application of the suite based on the historical behavior of the second application. An expected cost that is likely to be incurred for deploying the suite of applications is computed based on cost to be incurred for deploying each application of the suite in its respective suitable deployment environment. The expected cost may be, for example, third aggregated cost explained with reference to FIG. 2. Further, a first aggregated cost to be incurred for deploying each application of the suite in the first deployment environment and a second aggregated cost to be incurred for deploying each application of the suite in the second deployment environment are computed, as explained with reference to FIG. 2. The expected cost, the first aggregated cost, and the second aggregated cost may be published, for example, for viewing by the user, such as an administrator of the suite of applications.

Upon the publication, if an approval for the expected cost from the administrator of the suite of applications, the instructions are executable to deploy each application of the suite in its respective suitable deployment environment. Upon deployment of the applications of the suite, the instructions are executable to monitor an actual cost incurred for hosting the suite of applications. The actual cost may be, for example, the actual cost 326. The actual cost may then be compared with the expected cost. In response to the actual cost being different than the expected cost, it is determined as to whether an application of the suite is to be deployed in a deployment environment different than its current deployment environment, i.e., the deployment environment in which it is deployed. Such a determination may be performed, for example, upon identifying a cause of the difference. For instance, if the difference is because of change in the behavior of an application, such as change in frequency of operation or runtime duration of the application, it may be determined if the application is to be moved from its current deployment environment.

The present subject matter provides efficient and improved techniques for selecting application deployment environments for applications and for deploying the applications. The present subject matter makes the process of deployment of a suite of applications an improved, more efficient, and a simple one. Using the present subject matter, the cost incurred in deploying applications and a suite of applications in container-based deployment environments can be significantly reduced. Further, the performance of the applications can be improved.

The present subject matter can be utilized for deploying applications in public cloud, private cloud, and hybrid clouds. The present subject matter can also be used identifying suitable deployment environments for both newly-developed applications and older applications that are to be migrated from a private cloud to a public cloud.

The present subject matter provides flexibility to users in deployment of the applications by allowing selection of cloud service providers, data centers, and deployment environments.

Although implementations of selection of deployment environments for applications have been described in language specific to structural features and/or methods, it is to be understood that the present subject matter is not necessarily limited to the specific features or methods described. Rather, the specific features and methods are disclosed and explained as example implementations.

We claim:

1. A system comprising:
a processor; and
a memory comprising instructions executable by the processor to:
receive historical behavior of an application that is to be deployed in an application deployment environment;
select, based on the historical behavior, an application deployment environment for deployment of the application from among a container platform environment and a serverless computing environment; and
recommend the selected application deployment environment for deployment of the application.

2. The system of claim 1, comprising instructions executable by the processor to:
assess, based on the historical behavior, a first cost of operating the application in the container platform environment;
assess, based on the historical behavior, a second cost of operating the application in the serverless computing environment; and
select the application deployment environment based on the first cost and the second cost.

3. The system of claim 2, wherein, to recommend the selected application deployment environment, the instructions are executable by the processor to publish the first cost and the second cost.

4. The system of claim 1, comprising instructions executable by the processor to:
assess, based on the historical behavior, a first cost of operating the application in the container platform environment;
assess, based on the historical behavior, a second cost of operating the application in a serverless computing environment of a first cloud service provider;
assess, based on the historical behavior, a third cost of operating the application in a serverless computing environment of a second cloud service provider; and
select the application deployment environment based on the first cost, the second cost, and the third cost.

5. The system of claim 4, wherein, to assess the first cost and the second cost, the instructions executable by the processor to:
utilize a first costing model and a second costing model, wherein the first costing model indicates a dependency of cost to be incurred for hosting the application in the container platform environment on an expected behavior of the application, wherein the second costing model indicates a dependency of cost to be incurred for hosting the application in the serverless computing environment on the expected behavior of the application, wherein the expected behavior is determinable based on the historical behavior.

6. The system of claim 1, wherein the historical behavior of the application comprises at least one of:
a frequency of operation of the application;
a time duration for which the application runs for each initiation of the application;
a workload pattern of the application;
a resource consumption pattern of the application; and
statelessness of the application.

7. The system of claim 1, comprising instructions executable by the processor to monitor operation of the application over a predetermined time period to obtain the historical behavior.

8. The system of claim 1, comprising instructions executable by the processor to:
receive a response from a user to utilize the selected application deployment environment for deploying the application in response to the recommendation; and
deploy the application in the selected application deployment environment.

9. The system of claim 1, wherein the application is part of a suite of applications, and wherein the instructions are executable by the processor to:
select an application deployment environment for each application of the suite of applications based on a historical behavior of the application; and
recommend selected application deployment environment for each application of the suite of applications.

10. A method comprising:
monitoring a pattern of operation of an application in a predetermined time period, the pattern of operation comprising at least one of:
a number of times the application is operated in the predetermined time period;
a runtime duration of the application for each initiation of the application; and
workload pattern of the application in the predetermined time period;
selecting, based on the pattern of operation, an application deployment environment for the application from among a container platform environment and a serverless computing environment; and
deploying the application in the selected application deployment environment.

11. The method of claim 10, comprising selecting the container platform environment as the deployment environment in response to at least one of:
the number of times the application is operated in the predetermined time period being greater than an operation threshold;
the runtime duration being greater than a runtime threshold; and
the workload pattern of the application being stable.

12. The method of claim 10, comprising selecting the container platform environment as the deployment environment in response to the application being a stateful application.

13. The method of claim 10, comprising:
receiving a data center input indicating a data center in which the application is to be deployed; and
deploying the application in the selected application deployment environment in the indicated data center.

14. The method of claim 10, wherein the pattern of operation comprises a resource consumption pattern of the application, and wherein the method comprises:
determining, based on the resource consumption pattern, a size of the container to be instantiated for deploying the application; and
deploying the application in a container having the determined size.

15. The method of claim 10, comprising:
receiving a first costing model of the container platform environment, the first costing model indicating a dependency of cost to be incurred for hosting the application in the container platform environment on the pattern of operation of the application;
assessing a first cost for operating the application in the container platform environment based on the first costing model and the pattern of operation of the application;
receiving a second costing model of the serverless computing environment, the second costing model indicating a dependency of cost to be incurred for hosting the application in the serverless computing environment on the pattern of operation of the application;
assessing a second cost for operating the application in the serverless computing environment based on the second costing model and the pattern of operation of the application; and
selecting the application deployment environment based on the first cost and the second cost.

16. A non-transitory computer-readable medium comprising instructions, the instructions being executable by a processing resource to:
receive a request to deploy a first application in a container-based deployment environment;
obtain a first historical behavior of the first application, the first historical behavior comprising a frequency of operation of the first application and a runtime duration of the first application;
determine, based on the first historical behavior, that a cost for operating the first application in a first deployment environment is likely to be less than a cost for operating the first application in a second deployment environment wherein each of the first deployment environment and the second deployment environment is a container-based deployment environment; and
deduce, based on the determination, that the first deployment environment is a suitable deployment environment for deployment of the first application.

17. The non-transitory computer-readable medium of claim 16, wherein the first application is part of a suite of applications and wherein the instructions are executable to:
determine, from among the first deployment environment and the second deployment environment, a suitable deployment environment for each application of the suite based on a historical behavior of the application;
compute an expected cost to be incurred for deploying the suite of applications based on cost to be incurred for deploying each application of the suite in its respective suitable deployment environment;
compute a first aggregated cost to be incurred for deploying each application of the suite in the first deployment environment;
compute a second aggregated cost to be incurred for deploying each application of the suite in the second deployment environment; and
publish the expected cost, the first aggregated cost, and the second aggregated cost.

18. The non-transitory computer-readable medium of claim 17, wherein the instructions are executable to:
receive approval for the expected cost from an administrator of the suite of applications; and
deploy each application of the suite in its respective suitable deployment environment.

19. The non-transitory computer-readable medium of claim 18, wherein, upon deploying the applications of the suite, the instructions are executable by a processing resource to:
monitor an actual cost incurred for hosting the suite of applications;
compare the actual cost with the expected cost; and
determine, in response to a difference between the actual cost and the expected cost, whether an application of the suite is to be deployed in a deployment environment different than its current deployment environment.

20. The non-transitory computer-readable medium of claim 16, wherein, to determine that the cost for operating the first application in the first deployment environment is likely to be less than the cost for operating the first application in the second deployment environment, the instructions are executable to:
utilize a first costing model of the first deployment environment and a second costing model of the second deployment environment, wherein the first costing model indicates a dependency of cost to be incurred for hosting the first application in the first deployment environment on the first historical behavior and wherein the second costing model indicates a dependency of cost to be incurred for hosting the first application in the second deployment environment on the first historical behavior.
